(19) United States
(12) Patent Application Publication
(10) Pub. No.: US 2012/0166080 A1
(43) Pub. Date: Jun. 28, 2012

(54) METHOD, SYSTEM AND COMPUTER-READABLE MEDIUM FOR RECONSTRUCTING MOVING PATH OF VEHICLE

(75) Inventors: Shang-Chih Hung, Taichung City (TW); Yi-Fei Luo, Hsinchu County (TW); Jian-Ren Chen, Hsinchu County (TW); Luke Chen, New Taipei City (TW); Chieh-Chen Cheng, Taichung City (TW)

(73) Assignee: INDUSTRIAL TECHNOLOGY RESEARCH INSTITUTE, Hsinchu (TW)

(21) Appl. No.: 13/163,753

(22) Filed: Jun. 20, 2011

(30) Foreign Application Priority Data
Dec. 28, 2010 (TW) 99146378

(51) Int. Cl. G01C 21/34

(52) U.S. Cl. 701/448; 701/466

(57) ABSTRACT

A method, a system and a computer-readable medium for reconstructing a vehicle moving path are provided. In the method, a plurality of vehicle recognition results of a plurality of first monitoring frames captured by a plurality of first type road monitors are received and compared to find at least one similar vehicle. Next, according to a disposition location of each first road monitor and the comparison result of each vehicle, at least one passing spot and a driving time that each vehicle moves between the disposition locations are estimated. Then, tracking data of at least one moving object appeared in multiple second monitoring frames captured by multiple second type road monitors disposed in the passing spots is inquired. Finally, the vehicles are compared with the tracked moving objects to find the moving object associated with each vehicle, so as to construct a complete moving path of each vehicle.

### CROSS-REFERENCE TO RELATED APPLICATION

This application claims the priority benefit of Taiwan application serial no. 99146378, filed Dec. 28, 2010. The entirety of the above-mentioned patent application is hereby incorporated by reference herein and made a part of this specification.

### BACKGROUND

1. Field of the Disclosure

The disclosure relates to a method, a system and a computer-readable medium for vehicle tracking and reconstructing a vehicle moving path.

2. Description of Related Art

Conventionally, a position of a moving vehicle can be obtained through a global positioning system (GPS). An operation principle of such method is to install a GPS signal receiver on a target vehicle for receiving GPS signals in real time and upload positioning information to a post end host through a wireless communication interface, so as to track the position of the target vehicle. Such method is generally applied for fleet management. However, such method is limited in applications, especially in urban areas when the GPS signals are shielded by buildings and the receiver cannot receive the GPS signals. Moreover, since an additional device has to be installed on the target vehicle, it is not applicable for obtaining positions of non-specific targets. In addition, a method for tracking vehicles through monitoring images obtained by cameras disposed at street intersections has been provided.

A greatest challenge of tracking a specific target through different cameras is that moving objects detected by different cameras have to be re-identified to remove repeat data and maintain consistency of target information. Conventionally, cameras with an overlapped monitoring range are used, and based on a physical characteristic that the moving objects detected by the cameras in the overlapped region at a same time and a same position should be a same target object, the moving object detecting information of a plurality of the cameras are integrated. Such method depends on correctness of a moving object detecting algorithm and accuracy of coordinate conversion. Generally, when the monitoring images captured by the road cameras are analysed, an object positioning error caused by distortions of the moving object detecting algorithm and the coordinate conversion can be more than a half of a size of the target object, particularly, the greater a monitoring range is, the larger the error is, and the error is probably greater than the size of the target object. Therefore, when a plurality of moving objects are simultaneously moving within a same range, a chance of re-identification error is very high. In order to mitigate the above problem, a general method is to ameliorate the moving object detecting algorithm to improve information correctness of the object detection, or ameliorate the coordinate conversion to reduce positioning distortion.

In an actual application, since resolutions of the cameras disposed at the street intersections are not high, and monitoring ranges are relatively wide, quality of the obtained images is poor, so that it is hard to obtain a better result through the moving object detecting algorithm. Therefore, improvement effectiveness of ameliorating the moving object detecting algorithm or ameliorating the coordinate conversion is limited. Moreover, the moving object detecting algorithm is greatly influenced by a weather factor, and once it is used in outdoor applications, the generated errors are hard to be accepted. Due to the influences of the above problems, when the moving object is tracked through different cameras, correctness of a generated moving path is not high.

### SUMMARY OF THE DISCLOSURE

The disclosure is directed to a method, a system and a computer-readable medium for reconstructing a vehicle moving path, by which a vehicle recognition system and road monitors are simultaneously used to reconstruct the vehicle moving path.

The disclosure provides a method for reconstructing a vehicle moving path. In the method, vehicle recognition data is received, which includes a vehicle recognition result of each of a plurality of first monitoring frames captured by a plurality of first type road monitors. Then, the vehicle recognition results of the first monitoring frames are compared to find at least one similar vehicle. Next, according to a disposition location of each of the first type road monitors and a comparison result of the at least one vehicle, at least one passing spot and a driving time that the at least one vehicle moves between the disposition locations are estimated. Then, moving object tracking data is inquired, which includes tracking data of at least one moving object appeared in a plurality of second monitoring frames captured by a plurality of second type road monitors disposed in the at least one passing spot. Finally, the at least one vehicle is compared with the at least one moving object to find the moving object associated with each of the at least one vehicle, so as to construct a complete moving path of each of the at least one vehicle.

The disclosure provides a system for reconstructing a vehicle moving path, which includes a vehicle searching module and a path reconstructing module. The vehicle searching module receives a vehicle recognition result of each of a plurality of first monitoring frames captured by a plurality of first type road monitors, and compares the vehicle recognition results of the first monitoring frames to find at least one similar vehicle, and according to a disposition location of each of the first type road monitors and a comparison result of the at least one vehicle, the vehicle searching module estimates at least one passing spot and a driving time that the at least one vehicle moves between the disposition locations. The path reconstructing module inquires tracking data of at least one moving object appeared in a plurality of second monitoring frames captured by a plurality of second type road monitors disposed in the at least one passing spot, and compares the at least one vehicle with the at least one moving object to find the moving object associated with each of the at least one vehicle, so as to construct a complete moving path of the at least one vehicle.

The disclosure provides a computer-readable medium, which records a computer program to be loaded into an electronic device to execute following steps. First, vehicle recognition data is received, which includes a vehicle recognition result of each of a plurality of first monitoring frames captured by a plurality of first type road monitors. Then, the vehicle recognition results of the first monitoring frames are compared, so as to find at least one similar vehicle. Then, according to a disposition location of each of the first type road monitors and the comparison result of each vehicle, at least one passing spot and a driving time that each vehicle moves between the disposition locations are estimated. Then, tracking data of one moving object is inquired, which includes tracking data of at least one moving object appeared in a plurality of second monitoring frames captured by a plurality of second type road monitors disposed in the passing spots. Finally, the vehicles are compared with the moving objects to find the moving object associated with each of the vehicles, so as to construct a complete moving path of each of the vehicles.

According to the above descriptions, in the method, the system and the computer-readable medium for reconstructing a vehicle moving path of the disclosure, a vehicle recognition technique and a moving object tracking technique are used in collaboration with a vehicle comparison technique and a passing spot and time estimation technique to improve correctness of reconstructing the complete vehicle moving path, and a keyframe association establishing technique is used to improve correctness for inquiring related information of the target vehicle.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating a system for reconstructing a vehicle moving path according to a first exemplary embodiment of the disclosure.

FIG. 2 is a flowchart illustrating a method for reconstructing a vehicle moving path according to the first exemplary embodiment of the disclosure.

FIG. 3 is a schematic diagram illustrating a system for reconstructing a vehicle moving path according to a second exemplary embodiment of the disclosure.

FIG. 4 is a flowchart illustrating a method for reconstructing a vehicle moving path according to the second exemplary embodiment of the disclosure.

FIG. 5(a) and FIG. 5(b) are examples of calculating a minimum number of edit operations according to an exemplary embodiment of the disclosure.

FIG. 6 is a schematic diagram of a linear regression filtering result according to an exemplary embodiment of the disclosure.

FIG. 7 is a schematic diagram of a motion model according to an exemplary embodiment of the disclosure.

### DETAILED DESCRIPTION OF DISCLOSED EMBODIMENTS

Since cost of road monitors having a vehicle recognition function is relatively high, they are generally disposed at several major intersections, and general road monitors are disposed at other intersections. However, variation of types, speeds and directions of moving vehicles on the road is tremendous, and if vehicle recognition results of only several road monitors are used to reconstruct moving paths of the vehicles, correctness thereof cannot be guaranteed, especially when the vehicle passes a plurality of intersections, correctness of the moving path thereof is greatly reduced. In order to compensate information of the intersections without the vehicle recognition system, according to the method of the disclosure, the vehicle recognition system and the road monitors with relatively low cost compared to that having the vehicle recognition function are simultaneously used, and moving object tracking data generated according to a moving object tracking technique is used to compensate inadequacy of the vehicle paths generated only according to the vehicle recognition results.

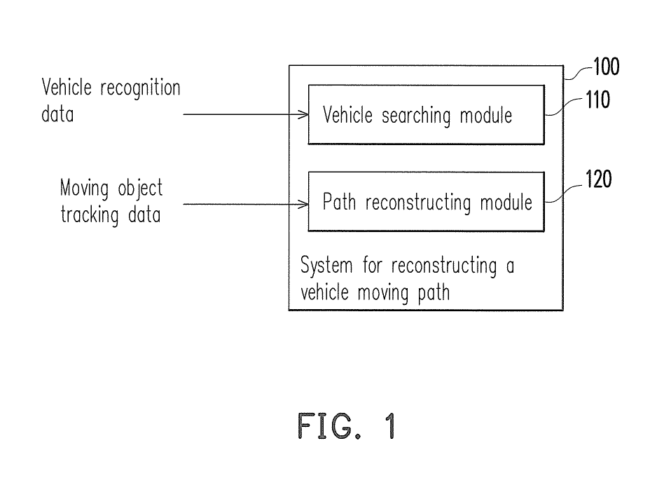

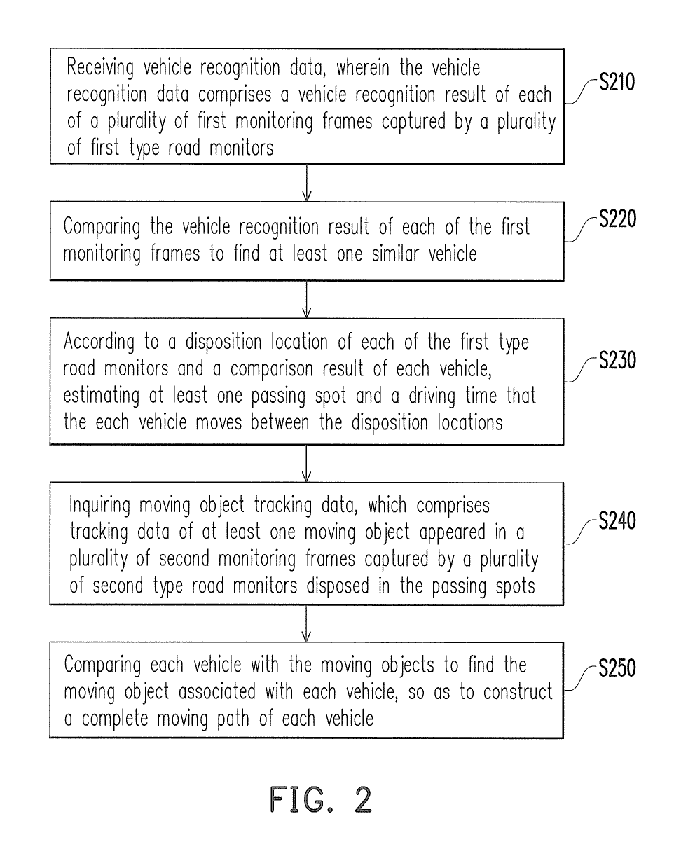

FIG. 1 is a block diagram illustrating a system for reconstructing a vehicle moving path according to a first exemplary embodiment of the disclosure. FIG. 2 is a flowchart illustrating a method for reconstructing a vehicle moving path according to the first exemplary embodiment of the disclosure. Referring to FIG. 1 and FIG. 2, the system 100 for reconstructing a vehicle moving path includes a vehicle searching module 110 and a path reconstructing module 120. The method of the present exemplary embodiment is described in detail below with reference of FIG. 2.

First, the vehicle searching module 110 receives vehicle recognition data from a vehicle recognition system (not shown) (step S210), where the vehicle recognition data includes a vehicle recognition result of each of a plurality of first monitoring frames captured by a plurality of first type road monitors. The first type road monitors support a license plate recognition function, and the first monitoring frames captured by the first type road monitors are sent to the vehicle recognition system to recognize the vehicles. The vehicle searching module 110 of the present exemplary embodiment receives the vehicle recognition results output by the vehicle recognition system.

Then, the vehicle searching module 110 compares the vehicle recognition result of each of the first monitoring frames to find at least one similar vehicle (step S220), and according to a disposition location of each of the first type road monitors and the comparison result of each vehicle, the vehicle searching module 110 estimates at least one passing spot and a driving time that each vehicle moves between the disposition locations (S230). In detail, since cost of the first type road monitors is relatively high, they are generally disposed at major intersections, even if a similar vehicle is appeared at two of the major intersections, a vehicle moving path between the two intersections cannot be determined. However, in the present exemplary embodiment, the possible passing spots and driving time that each vehicle moves between the two intersections are still obtained based on historical statistical information, so as to serve as basis for post vehicle tracking.

Then, the path reconstructing module 120 inquires moving object tracking data, which includes tracking data of at least one moving object appeared in a plurality of second monitoring frames captured by a plurality of second type road monitors disposed in the passing spots (step S240). The second type road monitors do not support the licence plate recognition function, though the monitoring frames captured by the second type road monitors can still be used to track the moving objects (i.e. the vehicles) appeared in the monitoring frames according to a moving object tracking technique for serving as a basis for reconstructing the moving path.

Finally, the path reconstructing module 120 compares the at least one vehicle found by the vehicle searching module 110 and the at least one inquired moving object according to time, space information and feature information such as color histograms of the vehicle and the moving object, so as to find the moving object associated with each of the vehicles, and accordingly construct a complete moving path of each of the vehicles (step S250). In brief, the path reconstructing module 120 finds the possible moving object appeared in the second type road monitors according to a time point that the vehicle found by the vehicle searching module 110 appear in each of the first type road monitors, and constructs the complete moving path the vehicle according to the vehicle recognition result and the moving object tracking result.

In overall, according to the method for reconstructing the vehicle moving path of the present exemplary embodiment, the output results of the vehicle recognition system and the moving object tracking system are integrated to construct the complete moving path of each of the vehicles, so as to improve correctness of information and reconstruct complete vehicle moving paths.

It should be noticed that after the complete moving path of each of the vehicles is reconstructed, shooting time of keyframes are obtained to further find the keyframes corresponding to the vehicle moving path, and an association between the vehicle moving path and the keyframes is established to serve as basis for post vehicle moving path inquiry. Another exemplary embodiment is provided below for detailed descriptions.

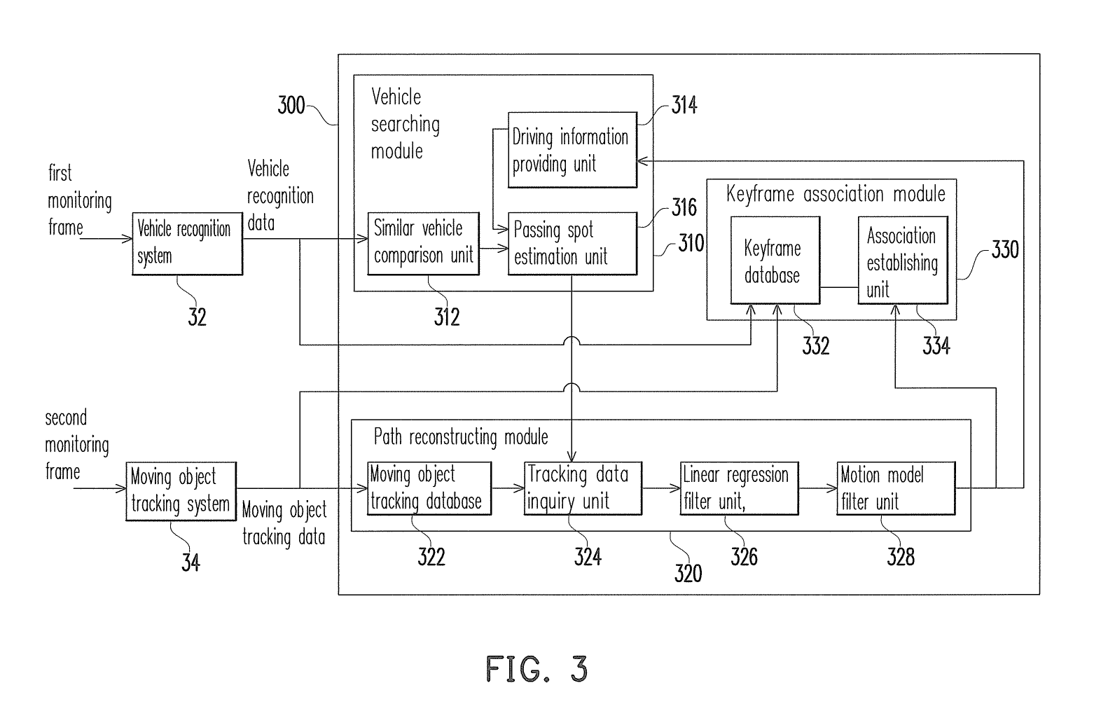

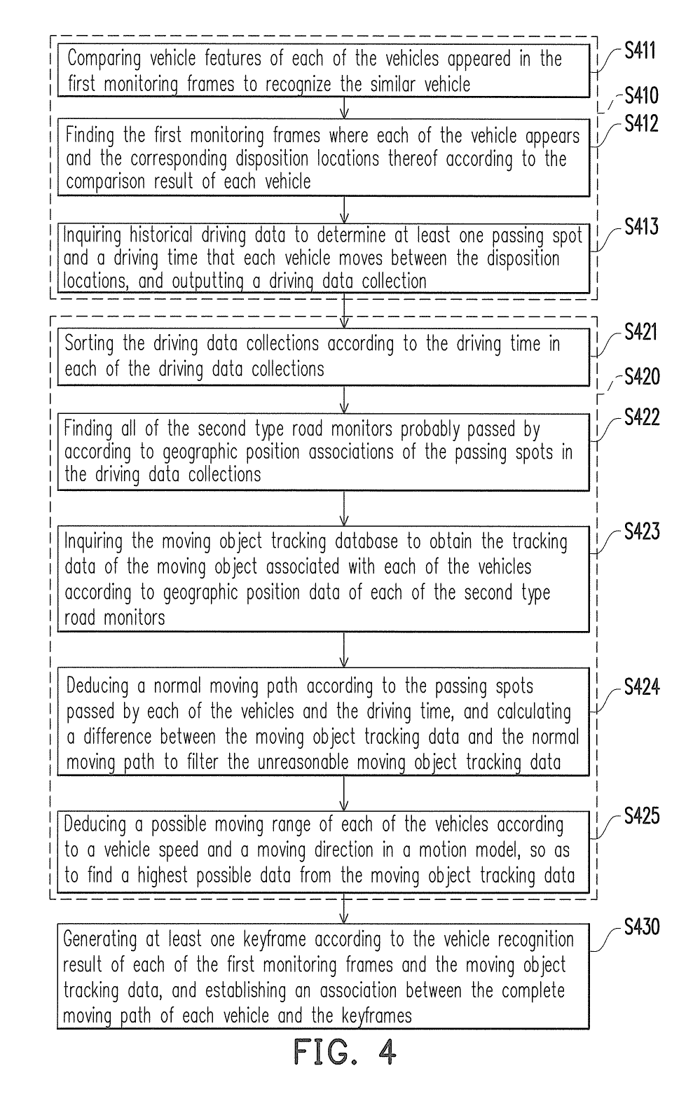

FIG. 3 is a schematic diagram illustrating a system for reconstructing a vehicle moving path according to a second exemplary embodiment of the disclosure. FIG. 4 is a flowchart illustrating a method for reconstructing a vehicle moving path according to the second exemplary embodiment of the disclosure. Referring to FIG. 3 and FIG. 4, the system 300 for reconstructing a vehicle moving path includes a vehicle searching module 310, a path reconstructing module 320 and a keyframe association module 330. The method of the present exemplary embodiment is described in detail below with reference of FIG. 4.

First, the vehicle searching module 310 receives vehicle recognition results from a vehicle recognition system 32, and compares the vehicle recognition results of the first monitoring frames to find at least one similar vehicle appeared in the first monitoring frames (step S410).

In detail, the vehicle searching module 310 may include a similar vehicle comparison unit 312, a driving information providing unit 314 and a passing spot estimation unit 316. The similar vehicle comparison unit 312 is used for comparing a vehicle feature of each of the vehicles appeared in the first monitoring frames to recognize the similar vehicle (step S411). The vehicle feature used for recognizing the similar vehicle may include a vehicle licence plate, a vehicle color, and a vehicle type, etc., which is not limited by the disclosure.

Taking the licence plate as an example, in the present exemplary embodiment, a difference between plate numbers of two vehicles is defined as an edit distance, and a magnitude of the edit distance is used to determine whether the two vehicles are the same or similar.

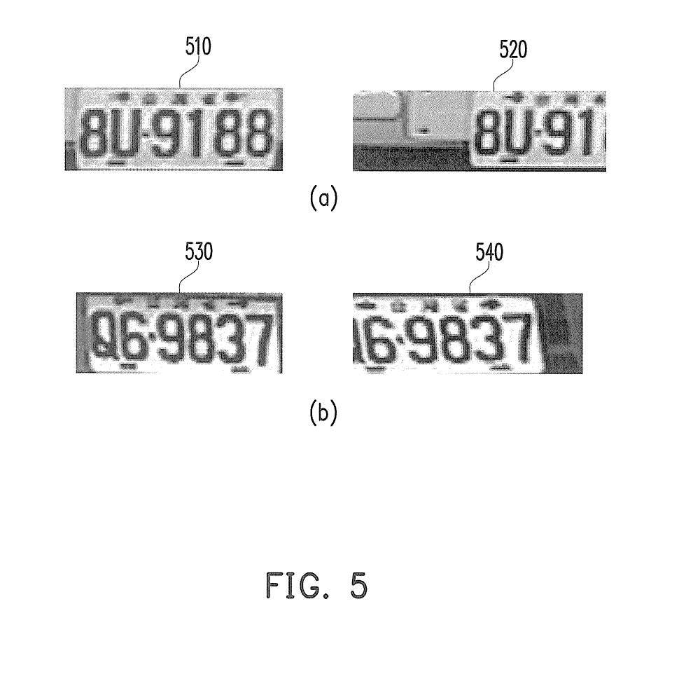

In detail, the edit distance is defined as a minimum number of edit operations required for transforming a character string A to a character string B between two character strings A and B, and a standard edit operation includes replacing a single character and inserting a character. For example, FIG. 5(a) and FIG. 5(b) are examples of calculating the minimum number of edit operations according to an exemplary embodiment of the disclosure. In a plate image 520 of FIG. 5(a), tail numbers 88 of a plate image 510 are removed, and a minimum number of edit operations required for achieving such difference is 2. Moreover, in a plate image 540 of FIG. 5(b), a front code Q of a plate image 530 is removed, and a minimum number of edit operations required for achieving such difference is 1. The above edit distance can be used to quantize the difference between the plate numbers, and a magnitude of the minimum number of edit operations can be used to determine whether the two vehicles are the similar vehicle.

According to the above descriptions, the similar vehicle comparison unit 312, for example, captures plate numbers (i.e. a first plate number and a second plate number) of any two vehicles appeared in the first monitoring frames, and calculates a minimum number of edit operations required for transforming the first plate number to the second plate number, and compares it with a threshold value, where when the minimum number of the edit operations is smaller than or equal to the threshold value, the two vehicles are determined to be the similar vehicle.

Referring to FIG. 3, the passing spot estimation unit 316 finds the first monitoring frames where each of the vehicles appears and the corresponding disposition locations thereof according to the comparison result of each vehicle output by the similar vehicle comparison unit 312 (step S412), and inquires historical driving data provided by the driving information providing unit 314 to determine at least one passing spot and a driving time that each vehicle moves between the disposition locations, and finally outputs a driving data collection (step S413).

In detail, the driving information providing unit 314 is used for storing and providing the historical driving data including at least one passing spot and a corresponding driving time that the vehicles used to move between the disposition locations of the first type road monitors. Where, the driving information providing unit 314, for example, analyses historical traffic data of each of the intersections in advance, and, for example, establishes a driving timetable of each of the intersections and moving paths between the connected intersections according to a mean and a standard deviation of statistical analysis to serve as basis for determining the vehicle passing spots and the driving time.

Moreover, during a system operation period, the passing spot estimation unit 316 receives the vehicle comparison results output by the similar vehicle comparison unit 312, and estimates a chance that a target vehicle appears at each of the intersections according to the historical traffic data of each of the intersections, so as to generate a primary passing intersection data collection. Then, the estimated primary passing intersection data collection is compared to the driving timetable of each of the intersections to remove data unreasonable in time (for example, too long or short driving time interval), so as to generate a secondary passing intersection data collection.

Then, the path reconstructing module 320 inquires tracking data of at least one moving object appeared in a plurality of second monitoring frames captured by a plurality of second type road monitors disposed in the passing spots, and compares each of the vehicles and the moving objects according to time and space information and feature information such as color histograms, so as to find the moving object associated with each of the vehicles. Where, regarding the time information, the one closest to a past statistical target value is used to establish the association, for example, according to a past statistical result, time intervals of 99% of the moving objects are between 3 seconds and 5 seconds, and the moving objects closest to the average 4 seconds has a highest association degree. Regarding the space information, the association is established by searching the moving objects appeared at two adjacent intersections or within a certain specific distance. The time and space information can be integrated into speed information, and the associations can be established according to the past statistical results. The feature information is represented by a feature vector matrix, and similarity of two feature vector matrices is calculated. Association of the two feature vector matrices can be calculated according to a general correlation coefficient method to obtain the similarity, for example, the pearson correlation coefficient or a geometric distance correlation coefficient, etc. While the above comparison is performed, the path reconstructing module 320 further removes unreasonable moving object tracking data according to a linear regression filter method, and connects the moving object tracking data as a moving trail according to a time and space motion model, so as to construct a complete and correct moving path of each of the vehicles (step S420).

In detail, the path reconstructing module 320 includes a moving object tracking database 322, a tracking data inquiry unit 324, a linear regression filter unit 326 and a motion model filter unit 328. The moving object tracking database 322 is used for storing analysis data analysed by a moving object tracking system 34 such as a position, a time, a size, a color and a keyframe of each of the moving objects appeared in the second monitoring frames. The moving object tracking system 34 tracks the moving objects appeared in the second monitoring frames captured by the second type road monitors, and analyses the position, the time, the size, the color and the keyframe of each of the moving objects appeared in the second monitoring frames, and stores the analysis results into the moving object tracking database 322. The second type road monitors do not support the licence plate recognition function, though the monitoring frames captured by the second type road monitors are sent to the moving object tracking system 34, and the moving object tracking system 34 tracks the moving objects.

The tracking data inquiry unit 324 receives the driving data collection corresponding to each of the vehicles that is output by the passing spot estimation unit 316 of the vehicle searching module 310, sorts the driving data collections according to the driving time in each of the driving data collections (step S421), finds all of the second type road monitors probably passed by according to geographic position associations of the passing spots in the driving data collections (step S422), and inquires the moving object tracking database 322 to obtain the moving object tracking data of the moving object associated with each of the vehicles according to geographic position data of each of the found second type road monitors (step S423).

In detail, the path reconstructing module 320 has two data input sources, where a first data input source is the data generated according to the moving object tracking technique, and such data includes information such as position information, time, size, and keyframe, etc. of the moving object, and during the operation period of the system, such data is continuously generated and stored in the data storage medium (i.e. the moving object tracking database 322) of the system; a second data input source is the passing intersection data collection output by the vehicle searching module 310. After the tracking data inquiry unit 324 of the path reconstructing module 320 receives the passing intersection data collection, the tracking data inquiry unit 324 sorts the passing intersection data collections according to each intersection passing time, finds all of the road monitors probably passed by according to geographic position associations thereof, and obtains the corresponding moving object tracking data from the moving object tracking database 322 according to geographic position information of the road monitors.

It should be noticed that the path reconstructing module 320 further includes the linear regression filter unit 326 and the motion model filter unit 328, which are used to filter out unreasonable moving object tracking data. A method for the path reconstructing module 320 reconstructing the moving path includes two stages, by which the unreasonable moving object tracking data is first filtered out according to a linear regression filter method, and then the moving objects tracking data is connected as a moving trail according to the time and space motion model.

The linear regression filter unit 326 deduces a normal moving path according to the passing spots passed by each of the vehicles and the driving time, and calculates a difference between the moving object tracking data and the normal moving path to filter out the unreasonable moving object tracking data (step S424). In detail, according to the passing intersection data collection of the target vehicle obtained in the above step, possible time ranges that the target vehicle passes the other intersections only installed with the road monitors can be deduced, and the moving object tracking data is obtained from the moving object tracking database 322. Moreover, the normal moving path deduced in the aforementioned step is used as a reference to calculate time and space differences of all of the moving object tacking data, so as to filter out the unreasonable tracking data.

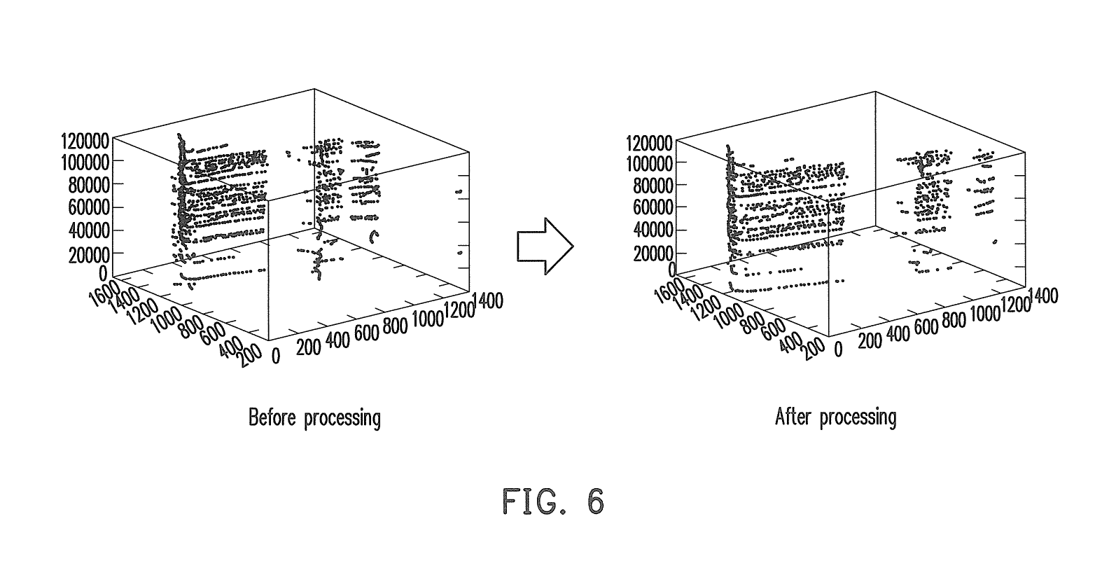

For example, FIG. 6 is a schematic diagram of a linear regression filtering result according to an exemplary embodiment of the disclosure. Referring to FIG. 6, the linear regression filtering operation of the present exemplary embodiment is performed in allusion to each batch of the original moving object tracking data, by which a distance between the tracking data and the normal moving path is calculated, and outliers are filtered to obtain a reasonable moving object tracking data.

On the other hand, the motion model filter unit 328 deduces a possible moving range of each of the vehicles according to a vehicle speed and a moving direction in a motion model, so as to find a highest possible moving object tracking data from the moving object tracking data generated by the linear regression filter unit 326 (step S425). In detail, since in most cases, the number of the moving vehicles in a same area is plural, and limited by a road condition, moving directions of the vehicles are probably the same (either in the same direction or opposite direction), and due to a positioning error in tracking of the moving object, a plurality of objects are probably located in a same location at a same time, especially when vehicles in a counter lane pass by the target vehicle. Therefore, after the linear regression filtering, a motion model is used to handle the remaining moving object tracking data to reduce an influence of the above situation. Since the tracked target is a vehicle, and motion of the vehicle is limited by physical laws, for example, a speed and a changing rate of the moving direction, etc., in the present exemplary embodiment, a deduced motion model is used to select the highest possible moving object tracking data.

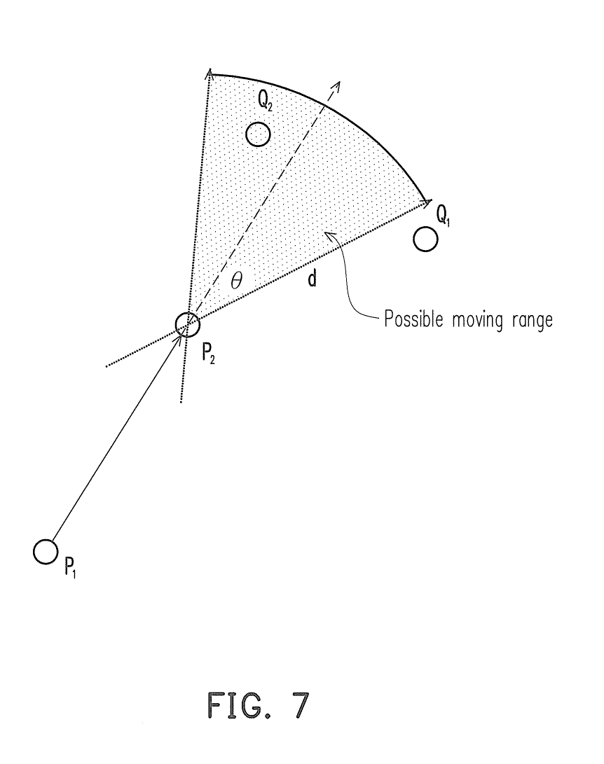

For example, FIG. 7 is a schematic diagram of a motion model according to an exemplary embodiment of the disclosure. Referring to FIG. 7, a vector is formed by a previous position P₁ and a current position P₂ of the vehicle, and a possible moving range is established at the current location P₂, where d represents a maximum moving distance of the vehicle that is obtained according to the historical data, and θ is a range angle. Based on such possible moving range, the outliers (for example, a position Q₁) can be filtered out, and similarity comparison is performed to all of the inliers (for example, a position Q₂) to find the most similar point. Finally, the above step is repeated to reconstruct the complete moving path.

Finally, the keyframe association module 330 generates at least one keyframe according to the vehicle recognition result of each of the first monitoring frames output by the vehicle recognition system 32 and the moving object tracking data output by the moving object tracking system 34, and establishes an association between the complete moving path of each vehicle and the keyframes to serve as a basis for post vehicle searching (step S430).

The keyframe association module 330 may include a keyframe database 332 and an association establishing unit 334. The keyframe database 332 stores the at least one keyframe generated according to the vehicle recognition results of the first monitoring frames and the moving object tracking data. The association establishing unit 334 constructs the association between the moving path of each vehicle and the keyframes to serve as a basis for post vehicle searching.

In detail, the keyframe association module 330 has three data input sources, where a first data input source is the vehicle recognition results generated by the vehicle recognition system, and the vehicle recognition system generally generates one or multiple recognition result images; a second data input source is the keyframes generated by the aforementioned moving object tracking system, where one or multiple keyframes can be generated according to different techniques; and a third data input source is the vehicle moving path (i.e. the complete moving path) of each of the vehicles generated by the path reconstructing module 320. Since the vehicle moving path includes data generated by moving object tracking, one or multiple keyframes can be obtained according to information such as time, space and monitor number, etc. of the data, and the association between the keyframes and the vehicle path can be established. Moreover, since the vehicle moving path also includes the results generated by the vehicle recognition system, the recognition result images generated by the vehicle recognition system are also associated with the vehicle moving path.

The disclosure provides a computer-readable medium, which records a computer program to be loaded into an electronic device to execute the steps of the aforementioned method for reconstructing the vehicle moving path. The computer program is formed by a plurality of program instructions. Particularly, after the program instructions are loaded into a computer system and executed, the steps of the aforementioned method and a function of the system for reconstructing the vehicle moving path are implemented. In summary, in the method, the system and the computer-readable medium for reconstructing the vehicle moving path of the disclosure, the vehicle recognition system and the road monitors with relatively low cost compared to that having the vehicle recognition function are simultaneously used, and moving object tracking data generated according to the existing moving object tracking technique is used to compensate inadequacy of the vehicle moving paths generated only according to the vehicle recognition results. Moreover, according to information such as time and monitor number, etc. in the moving object tracking data and the vehicle recognition data, one or multiple keyframes are obtained from the keyframe database, and the association between the keyframes and the vehicle moving path is established to serve as basis for post vehicle moving path inquiry.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for reconstructing a vehicle moving path, comprising:
receiving vehicle recognition data, wherein the vehicle recognition data comprises a vehicle recognition result of each of a plurality of first monitoring frames captured by a plurality of first type road monitors;
comparing the vehicle recognition result of each of the first monitoring frames to find at least one similar vehicle;
according to a disposition location of each of the first type road monitors and a comparison result of the at least one vehicle, estimating at least one passing spot and a driving time that the at least one vehicle moves between the disposition locations;
inquiring moving object tracking data, wherein the moving object tracking data comprises tracking data of at least one moving object appeared in a plurality of second monitoring frames captured by a plurality of second type road monitors disposed in the at least one passing spot; and
comparing the at least one vehicle with the at least one moving object to find the moving object associated with each of the at least one vehicle, so as to construct a complete moving path of the at least one vehicle.

2. The method for reconstructing the vehicle moving path as claimed in claim 1, wherein the step of comparing the vehicle recognition result of each of the first monitoring frames to find the at least one similar vehicle comprises:
comparing at least one vehicle feature of the vehicles appeared in the first monitoring frames to recognize the at least one similar vehicle.

3. The method for reconstructing the vehicle moving path as claimed in claim 2, wherein the step of comparing the at least one vehicle feature of the vehicles appeared in the first monitoring frames to recognize the at least one similar vehicle comprises:
capturing a first plate number and a second plate number of any two vehicles appeared in the first monitoring frames;
calculating a minimum number of edit operations required for transforming the first plate number to the second plate number, and comparing the minimum number of the edit operations with a threshold value; and
determining the two vehicles to be the similar vehicle when the minimum number of the edit operations is smaller than or equal to the threshold value.

4. The method for reconstructing the vehicle moving path as claimed in claim 2, wherein the at least one vehicle feature comprises a license plate, a vehicle color or a vehicle type.

5. The method for reconstructing the vehicle moving path as claimed in claim 1, wherein the step of estimating the at least one passing spot and the driving time that the at least one vehicle moves between the disposition locations according to the disposition location of each of the first type road monitors and the comparison result of the at least one vehicle comprises:
finding the first monitoring frames where the at least one vehicle appears and the corresponding disposition locations according to the comparison result of the at least one vehicle; and
inquiring historical driving data to determine the at least one passing spot and the driving time that the at least one vehicle moves between the disposition locations, and outputting a driving data collection,
wherein the historical driving data comprises the at least one passing spot and the corresponding driving time that the vehicles used to move between the disposition locations.

6. The method for reconstructing the vehicle moving path as claimed in claim 1, wherein before the step of inquiring the moving object tracking data, the method further comprises:
storing a position, a time, a size, a color and a keyframe of the at least one moving object appeared in the second monitoring frames into a moving object tracking database.

7. The method for reconstructing the vehicle moving path as claimed in claim 6, wherein the step of comparing the at least one vehicle with the at least one moving object to find the moving object associated with the at least one vehicle, so as to construct the complete moving path of the at least one vehicle comprises:
receiving the driving data collection corresponding to each of the at least one vehicle;
sorting the driving data collections according to the driving time of each of the driving data collections;
finding all of the second type road monitors probably passed by according to a geographic position association of the at least one passing spot in the driving data collections;
inquiring the moving object tracking database to obtain the at least one moving object tracking data of the moving object associated with the at least one vehicle according to geographic position data of each of the found second type road monitors; and
constructing the complete moving path of each of the at least one vehicle according to the driving data collection of the at least one vehicle and the at least one moving object tracking data of the moving object associated with the at least one vehicle.

8. The method for reconstructing the vehicle moving path as claimed in claim 7, wherein the step of obtaining the moving object associated with the at least one vehicle comprises:
comparing time information of the at least one vehicle and the at least one moving object to search the moving object with an appearing time closest to a historical statistic time interval, so as to establish association with the at least one vehicle.

9. The method for reconstructing the vehicle moving path as claimed in claim 7, wherein the step of obtaining the moving object associated with each of the at least one vehicle comprises:
comparing space information of the at least one vehicle and the at least one moving object to search the moving object appeared at two adjacent intersections or within a specific distance, so as to establish association with each of the at least one vehicle.

10. The method for reconstructing the vehicle moving path as claimed in claim 7, wherein the step of obtaining the moving object associated with the at least one vehicle comprises:
representing each of the at least one vehicle and each of the at least one moving object by a corresponding feature vector matrix;
obtaining a similarity between each two of the feature vector matrices; and
establishing association between the vehicle and the moving object corresponding to the feature vector matrix having the highest similarity.

11. The method for reconstructing the vehicle moving path as claimed in claim 7, wherein after the step of obtaining the at least one moving object tracking data of the moving object associated with the at least one vehicle, the method further comprises:
deducing a normal moving path according to the at least one passing spot passed by the at least one vehicle and the driving time; and
calculating a difference between the at least one moving object tracking data and the normal moving path to filter out unreasonable moving object tracking data.

12. The method for reconstructing the vehicle moving path as claimed in claim 11, wherein after the step of calculating the difference between the at least one moving object tracking data and the normal moving path to filter out the unreasonable moving object tracking data, the method further comprises:
deducing a possible moving range of the at least one vehicle according to a vehicle speed and a moving direction in a motion model, so as to find a highest possible moving object tracking data from the moving object tracking data already filtering out the unreasonable moving object tracking data.

13. The method for reconstructing the vehicle moving path as claimed in claim 7, wherein after the step of constructing the complete moving path of the at least one vehicle, the method further comprises:
establishing an association between the complete moving path of the at least one vehicle and at least one keyframe to serve as a basis for searching the at least one vehicle according to the vehicle recognition result of each of the first monitoring frames and the at least one keyframe included in the at least one moving object tracking data.

14. The method for reconstructing the vehicle moving path as claimed in claim 1, wherein the first type road monitor supports license plate recognition, and the second type road monitor does not support the license plate recognition.

15. A system for reconstructing a vehicle moving path, comprising:
a vehicle searching module, configured to receive a vehicle recognition result of each of a plurality of first monitoring frames captured by a plurality of first type road monitors, and compare the vehicle recognition results of the first monitoring frames to find at least one similar vehicle, and according to a disposition location of each of the first type road monitors and a comparison result of the at least one vehicle, estimate at least one passing spot and a driving time that the at least one vehicle moves between the disposition locations; and
a path reconstructing module, configured to inquire tracking data of at least one moving object appeared in a plurality of second monitoring frames captured by a plurality of second type road monitors disposed at the at least one passing spot, and compare the at least one vehicle with the at least one moving object to find the moving object associated with each of the at least one vehicle, so as to construct a complete moving path of the at least one vehicle.

16. The system for reconstructing the vehicle moving path as claimed in claim 15, wherein the vehicle searching module comprises:
a similar vehicle comparison unit, configured to compare at least one vehicle feature of the vehicles appeared in the first monitoring frames to recognize the at least one similar vehicle.
a driving information providing unit, configured to provide historical driving data comprising the at least one passing spot and the corresponding driving time that the vehicles used to move between the disposition locations; and
a passing spot estimation unit, configured to find the first monitoring frames where the at least one vehicle appears and the corresponding disposition locations according to the comparison result of the at least one vehicle, and inquire the historical driving data to determine the at least one passing spot and the driving time that the at least one vehicle moves between the disposition locations, and outputting a driving data collection.

17. The system for reconstructing the vehicle moving path as claimed in claim 16, wherein the similar vehicle comparison unit captures a first plate number and a second plate number of any two vehicles appeared in the first monitoring frames, calculates a minimum number of edit operations required for transforming the first plate number to the second plate number, and compares the minimum number of the edit operations with a threshold value, and determines the two vehicles to be the similar vehicle when the minimum number of the edit operations is smaller than or equal to the threshold value.

18. The system for reconstructing the vehicle moving path as claimed in claim 16, wherein the at least one vehicle feature comprises a license plate, a vehicle color or a vehicle type.

19. The system for reconstructing the vehicle moving path as claimed in claim 15, wherein the path reconstructing module comprises:
a moving object tracking database, configured to store a position, a time, a size, a color and a keyframe of the at least one moving object appeared in the second monitoring frames;
a tracking data inquiry unit, configured to receive the driving data collection corresponding to each of the at least one vehicle, sorting the driving data collections according to the driving time of each of the driving data collections, find all of the second type road monitors probably passed by according to a geographic position association of the at least one passing spot in the driving data collections, and inquire the moving object tracking database to obtain the at least one moving object tracking data of the moving object associated with the at least one vehicle according to geographic position data of each of the found second type road monitors.

20. The system for reconstructing the vehicle moving path as claimed in claim 19, wherein the tracking data inquiry unit compares time information of the at least one vehicle and the at least one moving object to search the moving object with an appearing time closest to a historical statistic time interval, so as to establish association with each of the at least one vehicle.

21. The system for reconstructing the vehicle moving path as claimed in claim 19, wherein the tracking data inquiry unit compares space information of the at least one vehicle and the at least one moving object to search the moving object appeared at two adjacent intersections or within a specific distance, so as to establish association with each of the at least one vehicle.

22. The system for reconstructing the vehicle moving path as claimed in claim 19, wherein the tracking data inquiry unit represents each of the at least one vehicle and each of the at least one moving object by a corresponding feature vector matrix, obtains a similarity between each two of the feature vector matrices, and establishes association between the vehicle and the moving object corresponding to the feature vector matrix having the highest similarity.

23. The system for reconstructing the vehicle moving path as claimed in claim 19, wherein the path reconstructing module further comprises:
a linear regression filter unit, configured to deduce a normal moving path according to the at least one passing spot passed by the at least one vehicle and the driving time, and calculate a difference between the at least one moving object tracking data and the normal moving path to filter out unreasonable moving object tracking data.

24. The system for reconstructing the vehicle moving path as claimed in claim 19, wherein the path reconstructing module further comprises:
a motion model filter unit, configured to deduce a possible moving range of the at least one vehicle according to a vehicle speed and a moving direction in a motion model, so as to find a highest possible moving object tracking data from the moving object tracking data already processed by linear regression filtering.

25. The system for reconstructing the vehicle moving path as claimed in claim 19, further comprising:
a keyframe association module, comprising:
a keyframe database, configured to store at least one keyframe generated according to the vehicle recognition result of each of the first monitoring frames and the at least one moving object tracking data; and
an association establishing unit, configured to establish an association between the complete moving path of the at least one vehicle and at least one keyframe to serve as a basis for searching the at least one vehicle.

26. The system for reconstructing the vehicle moving path as claimed in claim 15, wherein the first type road monitor supports license plate recognition, and the second type road monitor does not support the license plate recognition.

27. A computer-readable medium, which records a computer program to be loaded into an electronic device to execute the method for reconstructing the vehicle moving path as claimed in claim 1.
